(19) United States
(12) Patent Application Publication
(10) Pub. No.: US 2020/0364934 A1
(43) Pub. Date: Nov. 19, 2020

(54) 3D RENDERING SOFTWARE

(71) Applicant: Benka, Inc., Vero Beach, FL (US)

(72) Inventors: Gary Dillaman, Titusville, FL (US); Matthew Baker, Titusville, FL (US)

(73) Assignee: Benka, Inc., Vero Beach, FL (US)

(21) Appl. No.: 16/414,274

(22) Filed: May 16, 2019

(51) Int. Cl. G06T 17/10; G06T 19/20

(52) U.S. Cl. CPC G06T 17/10; G06T 19/20; G06T 2219/2004; G06T 2210/12; G06T 2210/21; G06T 2210/04

(57) ABSTRACT

A method for representing intersecting three-dimensional article models on a two-dimensional electronic display including the steps of: (1) creating an environmental model; (2) creating a first article model; (3) creating a second article model adapted to be carried by the first article model; (4) placing the first article model at a first location; (5) placing the second article model at a second location; (6) identifying an intersection between a volume of the first article model and a volume of the second article model; (7) creating a bounding box having a volume based upon a dimension of the second article model; (8) displaying the second article model on the two-dimensional electronic display; and (9) removing, from a display of the first article model on the two-dimensional electronic display, a volume of the first article model corresponding to the volume of the bounding box.

### FIELD OF THE INVENTION

The present invention relates to systems and methods for software design for three-dimensional graphics engines. More specifically, the present invention relates to a method for real time display of secondary items carried by primary objects.

### BACKGROUND OF THE INVENTION

Constructive solid geometry (CSG) may be used to create electronic displays of three-dimensional objects. When using CSG, it may be necessary to virtually cutout a portion of a first object to allow for placement of a second object that is nested within the first. By way of example and not as a limitation, a sink may be nested within a countertop or a shelf may be nested within a cabinet. Known functionality of three-dimensional rendering engines merges the two objects together, which requires the nested object to be rendered out of the object carrying the nested object, with the portion of the nested object carried by the carrying object being hidden. In known embodiments, the two three-dimensional models intersect each other and occupy the same three-dimensional space, even though this is not possible in the physical world. Rendering the objects to accommodate the intersection is time and resource intensive.

Additionally, in the physical world, there is typically only one chance to install a nested component without the loss of materials. Physically cutting out a sink multiple times to view how the sink would look in different locations in a countertop would not be practical or economical.

Therefore, there exists a need for a program that would eliminate the need to render nested items and allow designers, homeowners, or business owners to preview a location of a sink, or similar item, on a two-dimensional electronic display before committing to a location for the sink in the physical world.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a method for representing intersecting three-dimensional article models on a two-dimensional electronic display including the steps of: (1) creating an environmental model corresponding to a three-dimensional environment; (2) creating a first article model corresponding to a first three-dimensional object; (3) creating a second article mod& corresponding to a second three-dimensional object adapted to be carried by the first three-dimensional object; (4) placing the first article model at a first location in the environmental model; (5) placing the second article model at a second location in the environmental model; (6) identifying an intersection between a volume of the first article model and a volume of the second article mod& when the first article model is placed at the first location and the second article model is placed at the second location; (7) creating a bounding box having a volume based upon a dimension of the second article model; (8) displaying the second article model on the two-dimensional electronic display; and (9) removing, from a display of the first article model on the two-dimensional electronic display, a volume of the first article mod& corresponding to the volume of the bounding box.

The method may include the step of identifying the intersection between a volume of the first article model and a volume of the second article model when movement of the first article mod& or second article model within the environmental model is detected.

The method may include the step of dynamically removing, from the display of the first article model on the two-dimensional electronic display, a volume of the first article model corresponding to the volume of the bounding box at the intersection of the first article model and the second article model while the first article model moves from the first location to a third location or the second article model moves from the second location to a fourth location.

In one embodiment, the volume of the bounding box may correspond to a volume of the second article mod& defined by the outer dimensions of at least a portion of the second three-dimensional object received by the first three-dimensional object.

The method may include the steps of: (1) creating a plurality of article models each corresponding to a respective three-dimensional object adapted to carry the second three-dimensional object; (2) placing each of the plurality of article models at a respective location in the environment model; (3) identifying the intersection between a volume of each of the plurality of article models and a volume of the second article model when each of the plurality of article models is placed at the respective location and the second article model is placed at the second location; and (4) removing, from a display of each of the plurality of article models on the two-dimensional electronic display at a location of the intersection, a volume of the plurality of article models corresponding to the volume of the bounding box.

The method may include the steps of: (1) creating a plurality of article models each corresponding to a respective three-dimensional object adapted to be carried by the first three-dimensional object; (2) placing each of the plurality of article models at a respective location in the environment model; (3) identifying the intersection between a volume of each of the plurality of article models and a volume of the first article model when each of the plurality of article models is placed at the respective location and the first article model is placed at the first location; (4) creating the bounding box having a volume based upon a dimension of the plurality of article models; (5) displaying the plurality of article models on the two-dimensional electronic display; and (6) removing, from the display of the first article model on the two-dimensional electronic display at a location of the intersection, a volume of the first article model corresponding to the volume of the bounding box.

An embodiment of the inventive method for representing intersecting three-dimensional article models on a two-dimensional electronic display may include the steps of: (1) creating an environmental model corresponding to a three-dimensional environment; (2) creating a plurality of primary article models each corresponding to a respective three-dimensional object; (3) creating a plurality of secondary article models each corresponding to a respective three-dimensional object adapted to be carried by at least one of the plurality of primary article models; (4) placing at least one of the plurality of primary models at a respective primary model location in the environmental model; (5) placing at least one of the plurality of secondary models at a respective secondary model location in the environmental model; (6) identifying an intersection between a volume of at least one of the plurality of primary models and a volume of at least one of the plurality of secondary models when at least one of the plurality of primary models is placed at the respective primary model location and at least one of the plurality of secondary models is placed at the respective secondary model location; (7) creating a bounding box having a volume based upon a dimension of the at least one of the plurality of secondary models; (8) displaying at least one of the plurality of secondary models on the two-dimensional electronic display; and (9) removing, from a display of at least one of the plurality of primary models on the two-dimensional electronic display at a location of the intersection, a volume of at least one of the plurality of primary models corresponding to the volume of the bounding box.

The method may include the step of identifying the intersection between the volume of one of the plurality of primary models and the volume of one of the plurality of secondary models when movement of any of the plurality of primary models or the plurality of secondary models within the environmental model is detected.

The method may include the step of dynamically removing, from a display of at least one of the plurality of primary models on the two-dimensional electronic display, a volume of at least one of the plurality of primary models corresponding to the volume of the bounding box at the intersection while at least one of the plurality of primary models moves from a first respective primary model location to a second respective primary model location or at least one of the plurality of secondary models moves from a first respective secondary model location to a second respective secondary model location.

hi one embodiment, the volume of the bounding box may correspond to a volume of one of the plurality of secondary models defined by the outer dimensions of a portion of the respective three-dimensional object adapted to be carried by at least one of the plurality of primary article models.

The method for representing intersecting three-dimensional article models on a two-dimensional electronic display may including the steps of: (1) creating an environmental model corresponding to a three-dimensional environment; (2) creating a plurality of primary article models each corresponding to a respective three-dimensional object; (3) creating a plurality of secondary article models each corresponding to a respective three-dimensional object adapted to be carried by at least one of the plurality of primary article models; (4) placing at least one of the plurality of primary models at a respective primary model location in the environmental model; (5) placing at least one of the plurality of secondary models at a respective secondary model location in the environmental model; (6) identifying the intersection between a volume of at least one of the plurality of primary models and a volume of at least one of the plurality of secondary models when movement of any of the plurality of primary models or the plurality of secondary models within the environmental model is detected; (7) creating a bounding box having a volume corresponding to a volume of one of the plurality of secondary models defined by the outer dimensions of a portion of the respective three-dimensional object adapted to be carried by at least one of the plurality of primary article models; (8) displaying at least one of the plurality of secondary models on the two-dimensional electronic display; and (9) dynamically removing, from a display of at least one of the plurality of primary models on the two-dimensional electronic display, a volume of at least one of the plurality of primary models corresponding to the volume of the bounding box at the intersection while at least one of the plurality of primary models moves from a first respective primary model location to a second respective primary model location or at least one of the plurality of secondary models moves from a first respective secondary model location to a second respective secondary model location.

### BRIEF DESCRIPTION OF THE DRAWINGS

FIG. 1 is a flow chart of a method for representing intersecting three-dimensional article models on a two-dimensional electronic display according to an embodiment of the present invention.

FIGS. 2A and 2B are a flow chart of a method for representing intersecting three-dimensional article models on a two-dimensional electronic display according to an embodiment of the present invention.

FIGS. 3A and 3B are a flow chart of a method for representing intersecting three-dimensional article models on a two-dimensional electronic display according to an embodiment of the present invention.

FIGS. 4A and 4B are a flow chart of a method for representing intersecting three-dimensional article models on a two-dimensional electronic display according to an embodiment of the present invention.

FIGS. 5A and 5B are a flow chart of a method for representing intersecting three-dimensional article models on a two-dimensional electronic display according to an embodiment of the present invention.

FIGS. 6A and 6B are a flow chart of a method for representing intersecting three-dimensional article models on a two-dimensional electronic display according to an embodiment of the present invention.

FIGS. 7A and 7B are a flow chart of a method for representing intersecting three-dimensional article models on a two-dimensional electronic display according to an embodiment of the present invention.

### DETAILED DESCRIPTION OF THE INVENTION

The present invention will now be described more fully hereinafter with reference to the accompanying drawings, in which preferred embodiments of the invention are shown. However, this invention may be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings, Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a method for representing intersecting three-dimensional article models on a two-dimensional electronic display. The article models may be software defined components having dimension attributes, In one embodiment, the article models may be adapted to web-based design and the dimension attributes may be related to the drawable region of a web browser in which the objects may be displayed. The article models may be displayable on a two-dimensional electronic display with different physical appearances, including, but not limited to different shapes, colors, textures, or the like. The appearance of the article models may be configured by defining attributes associated with each article model. Article models may have a plurality of attributes, including, but not limited to height, width, depth, color, type, or the like, In some embodiments, an article model may comprise a plurality of other article models. An article model may represent or correspond to a three-dimensional object existing in the physical world.

The article models may represent or incorporate real world dimensions and physical constraints. The inventive system and methods 100, 200, 300, 400, 500, 600, and 700 may be particularly useful when building three-dimensional drawings of rooms in a residence or business, particularly in a kitchen, bathroom, utility room, or the like. The inventive system and methods 100, 200, 300, 400, 500, 600, and 700 may allow a designer to cutout a virtual void in a first article model to place a second article model, which nests within the first article model. By way of example and not as a limitation, nesting objects may include, but are not limited to, a sink inside of a cabinet or a countertop, a shelf inside of a cabinet, or the like. Nested items may be three-dimensional objects which would intersect with one another when placed as desired in a three-dimensional environment. Nested items may be three-dimensional models corresponding to objects that may have to be modified in the physical world to enable a first item to carry a second item.

When placing a nested article model, the system may create a virtual cutout, which may be defined by a bounding box. The volume of the article model within the bounding box may not be displayed. Removing this portion of the article model from the graphical display may provide a user with a visual indication of where the bounding boxes exist and what the article model nested within another article model looks like. The three-dimensional article models may be polled or bounding boxes may be calculated when one or more article model in an electronic environment is moved. The locations of three-dimensional article models may be used to determine if any bounding boxes need to be created.

In traditional methods of display or three-dimensional modeling, the intersection of the volumes of article models may prevent the three-dimensional article models from displaying as desired or may require resource or time intensive rendering to provide an accurate display of the intersecting models. By way of example, and not as a limitation, traditional methods of display may show a portion of a countertop filling a sink when the sink is placed in a location intersecting with the countertop, By way of another example, and not as a limitation, traditional methods of display may not display shelves when a shelf is placed in a location intersecting with a cabinet. The inventive method may solve this problem by identifying the intersection and subtracting a portion of a volume of one of the article models, which allows the remaining portions of the article models to appropriately and accurately display the desired appearance of the article models. By way of example, and not as a limitation, the inventive methods 100, 200, 300, 400, 500, 600, and 700 may display an interior surface of a sink when the sink is placed in a location intersecting with a countertop. By way of additional example, and not as a limitation, the inventive methods 100, 200, 300, 400, 500, 600, and 700 may display a shelf when the shelf is placed in a location intersecting with a cabinet.

The article models may utilize constructive solid geometry (CGS), which can assemble complex objects from simple objects. Using CGS, different objects may be added, subtracted, or joined to each other. In the inventive methods 100, 200, 300, 400, 500, 600, and 700 it may be possible to specify a primary article model, which may be, by way of example and not as a limitation, a cabinet, countertop, or other object adapted to carry another object, as well as a secondary article model, which may be, by way of example and not as a limitation, a sink or other object adapted to be carried by another object. The CGS paradigm may allow for the volume of the secondary object to be subtracted from the volume of the primary object, resulting in a hole the size of the outer bounds of the secondary article model within the geometry of the primary article model.

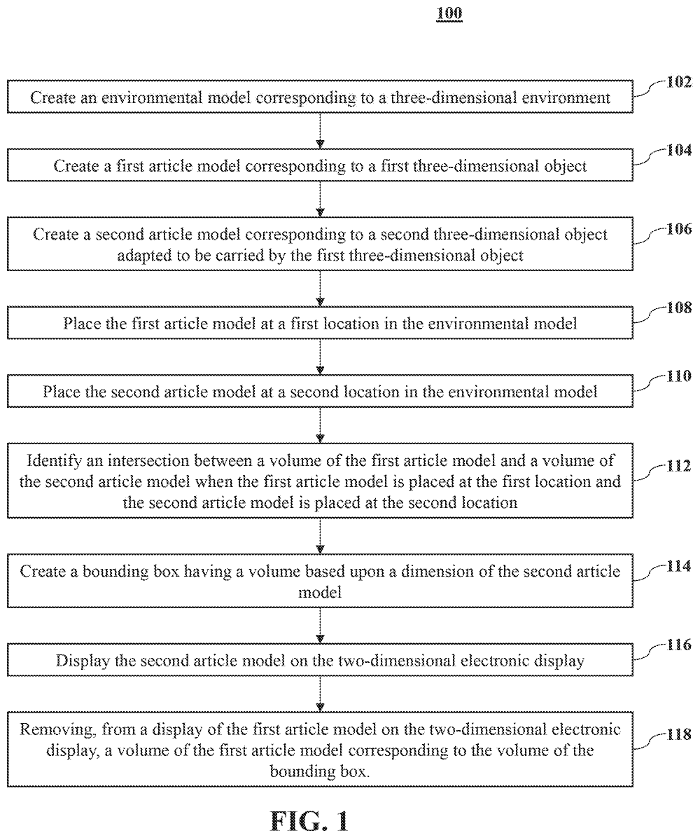

One method for representing intersecting three-dimensional objects on a two-dimensional electronic display is depicted at least in FIG. 1. The method 100 may include the step of creating an environmental model, which may correspond to a three-dimensional environment that could be created in the physical world (Step 102). The environmental model may be an electronic model of a room or other space, in which cabinets, counters, shelves, sinks, or the like may be placed. The environmental model may be created using the steps of: (1) creating a scene, (2) adding a camera to the scene, (3) adding a light to the scene, (4) adding the scene to a canvas. The scene may be subsequently referenced by software when adding walls or other delineations to the environmental model. In one embodiment, walls may be used as a container. Objects may be added to the scene within the bounds defined by the walls. A two-dimensional environmental model may be created in a 2-dimensional floorplan designer. A three-dimensional environmental model may be dynamically created based on the two-dimensional model.

A first article model, which may correspond to a first three-dimensional object, may be created (Step 104). A second article model, which may correspond to a second three-dimensional object, may be created (Step 106). The second three-dimensional object may be adapted to be carried by the first three-dimensional object, That is, in the physical world, the second three-dimensional object may be nested within the first three-dimensional object. By way of example, and not as a limitation, the first three-dimensional object may be a cabinet and the second three-dimensional object may be a sink, shelf, or other object that may be placed at least partially within the volume of the cabinet. By way of another example, and not as a limitation, the first three-dimensional object may by a countertop and the second three-dimensional object may be a sink or other object that may be placed at least partially within the volume of the countertop.

The first article model may be placed at a first location in the environmental model (Step 108). The second article model may be placed at a second location in the environmental model (Step 110).

Each of the first and second article models may have a volume. The volume may be defined by the outer dimensions of the corresponding three-dimensional objects. In an embodiment in which the first three-dimensional object is a cabinet, the volume of the cabinet may be defined as all space contained within the height, width, and depth dimensions of the cabinet even though the cabinet may not have physical material present within the entirety of the volume. In the physical world, the second three-dimensional object may be carried in a volume defined by the first three-dimensional object even when no physical material is required to be removed from the first three-dimensional object to create a physical space for the second three-dimensional object. By way of example, and not as a limitation, this may occur when the first three-dimensional object is a cabinet and the second three-dimensional object is a sink or a shelf. In some embodiments, in the physical world, a portion of the first three-dimensional object may be removed to allow the first three-dimensional object to carry the second three-dimensional object. By way of example, and not as a limitation, this may occur when the first three-dimensional object is a countertop and the second three-dimensional object is a sink.

In one embodiment, an intersection between the volume of the first article model and the volume of the second article model may be identified when the article models are placed in their respective locations in the environmental model (Step 112). The intersection may be defined as the three-dimensional space in the environment model occupied by the volume of both article models.

In one embodiment, the appropriate display of article models having intersecting volumes may be accomplished with the use of a bounding box. A bounding box may be defined to have a volume equal to the volume of the first article model that must be removed from the display to appropriately and accurately display the second article model when the volumes of the two article models intersect. hi one embodiment, the bounding box may be defined by the outer surfaces defining the portion of the second article model which intersects and is carried by a first article model. When intersecting article models are identified, a bounding box may be created (Step 114). The bounding box may have a volume and location based upon one or more dimensions of the second article model,

The second article model may by displayed on the two-dimensional electronic display at the second location (Step 116). A portion of the volume of the first article model corresponding to the volume and location of the bounding box, may be removed from the display of the first article model in the two-dimensional electronic display (Step 118).

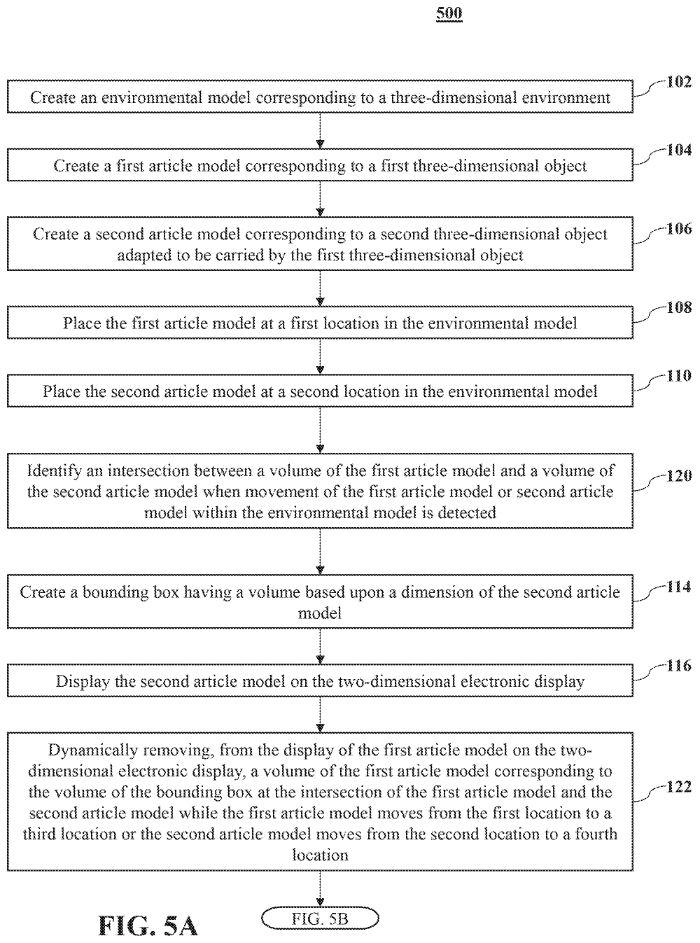

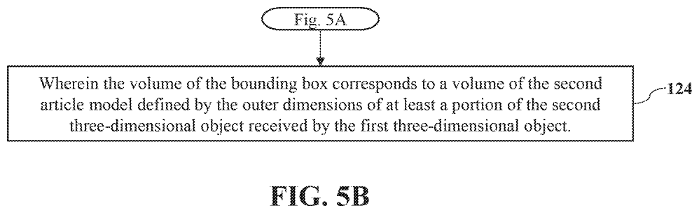

In one embodiment, as depicted at least in FIG. 5A, an intersection between a volume of the first article mod& and a volume of the second article mod& may be identified when movement of either the first article model or second article model is detected (Step 120). In such an embodiment, the system may poll article models in the environment to identify an intersection when any article model moves.

Each article model may have a type attribute. Values for the type attribute may include embeddable and floor. Embeddable type articles may be objects that may be carried by other objects. Floor type articles may be objects that may carry other objects. In one embodiment, when a floor or embeddable type article is moved in the environmental model, each article model in the environmental model is polled to determine if it is a floor type article. If a floor type article is located, each item in the environmental mod& is again polled to determine if it is an embeddable type article. For each identified embeddable type article, a bounding box may be created. The locations of the identified floor type and embeddable type articles may be compared to determine if there is any intersection. If the article models intersect, the bounding box may be utilized to remove the portion of the embeddable type article which intersects with the floor type article from the floor type article. In one embodiment, this may be done using the rebuildCounters method, which further utilizes the three.js library, which is available at https://github.com/mrdoob/three.js/ (last visited Apr. 30, 2019) and is hereby incorporated by reference in its entirety, along with the rebuildCounter and needupdate methods reproduced below.

public rebuildCounters(vec3)
{

//get all the objects in the scene
var objects = this.model.scene.getItems( );
//loop through each object
for (var i = 0; i < objects.length; i++)
{

//if a countertop
if (Items.Factory.getClass(objects[i].itemType)
==BP3D.Items.CountertopItem)
{

//rebuild the countertop
this.rebuildCounter(objects[i], vec3);

}
//if a cabinet
else if (Items.Factory.getClass(objects[i].itemType) ==
BP3D.Items.CabinetFloorItem)
{

//rebuild the cabinet
objects[i].rebuild( );

}

}

}

The rebuildCounter method may be called for each countertop or other embeddable type article model:

//rebuild counter
public rebuildCounter(counterItem: Item, vec3)
{

var needsUpdate = false;
//get the countertop geometry
var counterGeo = new THREE.BoxGeometry(counterItem.getWidth( ),
counterItem.getHeight( ), counterItem.getDepth( ));
//create mesh for the geometry
var counterMesh = new THREE.Mesh(counterGeo, counterItem.material);
//set the position
counterMesh.position.set(counterItem.position.x, counterItem.position.y,
counterItem.position.z);
//set the rotation
counterMesh.rotation.copy(counterItem.rotation);
//get the BSP object
var parentBSP = new ThreeBSP(counterMesh);
//get all objects in the scene
var objects = this.model.scene.getItems( );
//loop through all of hte objects
for (var i = 0; i < objects.length; i++)
{

//get the current object
var thisItem = objects[i];
//check if the item is an in item item
if (Items.Factory.getClass(thisItem.itemType) == BP3D.Items.InItemItem)
{

//set the bounding bpx
thisItem.geometry.computeBoundingBox( );
counterItem.geometry.computeBoundingBox( );
//clone the bounding box
var boundCounter = counterItem.geometry.boundingBox.clone( );
var boundItem = thisItem.geometry.boundingBox.clone( );
//check if the counter and the item intersect
if (BP3D.Core.Utils.boxIntersects(boundCounter, boundItem))
{

//an update is needed
needsUpdate = true;
//get the hole geometry (the item)
var holeGeo = new THREE.BoxGeometry(thisItem.getWidth( ),
thisItem.getHeight( ), thisItem.getDepth( ));
//create a mesh from the hole
var holeMesh = new THREE.Mesh(holeGeo);
//set the position
holeMesh.position.set(thisItem.position.x, thisItem.position.y,
thisItem.position.z);
//set the rotation
holeMesh.rotation.copy(thisItem.rotation);
//creat the child (hole) BSP object
var childBSP = new ThreeBSP(holeMesh);
//subtract the hole from the parent (cutout)
parentBSP = parentBSP.subtract(childBSP);

}

}

}
//if an update is required
if (needsUpdate)
{

//get the scene
var scene = this.model.scene.getScene( );
//remove the item from the scene
scene.remove(counterItem);
//create a mesh from the parent
var newMesh = parentBSP.toMesh(counterItem.material);
//get the geometry
var newGeo = newMesh.geometry as THREE.Geometry;
//compute normals
newGeo.computeFaceNormals( );
newGeo.computeVertexNormals( );
//set the material
counterItem.material = newMesh.material;
var matIndex = 0;
//loop through the faces
for (var i = 0; i < newGeo.faces.length; i++)
{

//increment the face
switch (i)
{

case 4:
matIndex++;
break;
case newGeo.faces.length-5:
matIndex++;
break;

}
//set the face index
newGeo.faces[i].materialIndex = matIndex;

}
//flag vertices to be updated
newGeo.verticesNeedUpdate = true;
//set the geometry
counterItem.geometry = newGeo;
//flag material to be updated
counterItem.material.needsUpdate = true;
//add the counter to the scene
scene.add(counterItem);

}

}

These methods are included by way of example only and not as a limitation. In the exemplary software provided, counters are objects depicted by the embeddable type article models and the floor type article models depict cabinets.

The inventive methods 100, 200, 300, 400, 500. 600, and 700 may allow the volume within the bounding box to be removed from the visual display of the floor type article models in real time. The result is that when an embeddable type article model moves within the environmental model, new virtual cutouts are automatically cut in intersecting floor type article models. In one embodiment, as depicted at least in FIG. 5A, a volume of the first article model corresponding to the volume of the bounding box at the intersection of the first article model and the second article model may be dynamically removed from the display of the first article model on the two-dimensional electronic display while the first article model moves from the first location to a third location or while the second article model moves from the second location to a fourth location (Step 122),

When the bounding box is being cutout from the floor type article model, a CSG routine may be called to subtract the bounding box from the floor type article model, Once the new geometry of the floor type article model with the bounding box subtracted is created, the original floor type article model is no longer displayed in the scene and the floor type article model with the bounding box subtracted is added to the scene, The original geometry of the floor type article model may persist in the floor type article model, but it may not be rendered. Whenever intersecting floor or embeddable type articles are moved, a new bounding box may be created and the geometry of the original floor type article model may be displayed or used to create a new virtual cutout instead of the version of the floor type article model with the previously subtracted bounding box. In one embodiment, as depicted at least in FIG. 5B, the volume of the bounding box may correspond to a volume of the second article model defined by the outer dimensions of at least a portion of the second three-dimensional article received by the first three-dimensional article (Step 124). The portion of the volume of the second article model that is used to calculate the bounding box may be determined by including an entirety of the portion of the volume of the second article model that intersects with a volume of the first article model.

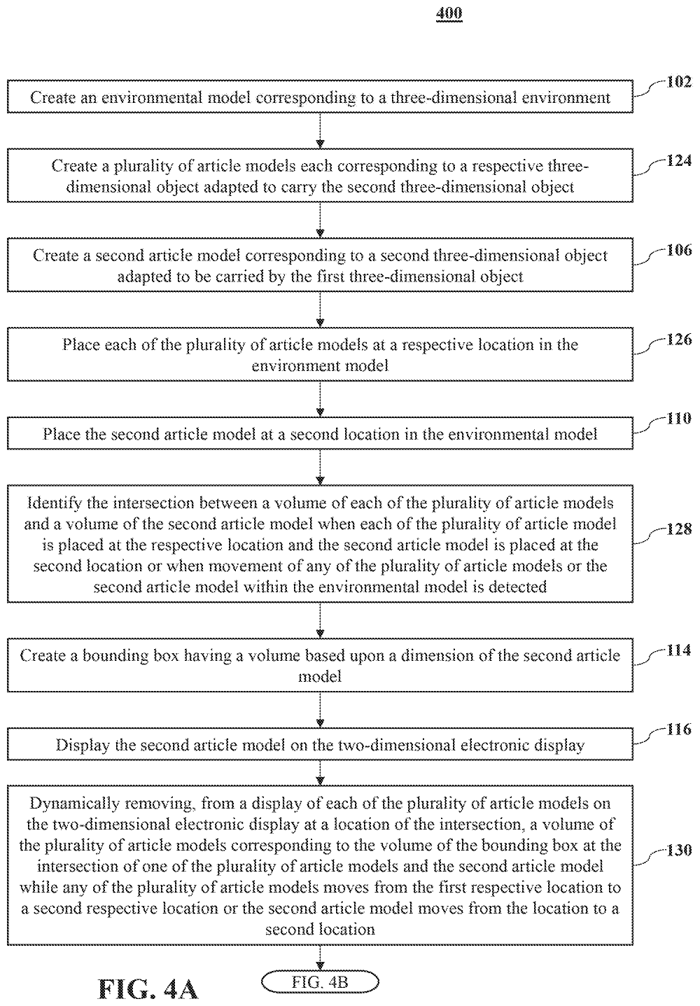

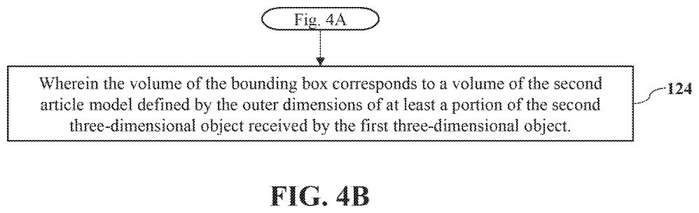

In one embodiment, as depicted at least in FIG. 4A, a plurality of article models each corresponding to a respective three-dimensional article and each adapted to carry a second three-dimensional article may be created (Step 126). In such an embodiment, each of the plurality of article models may be placed at a respective location in the environment model (Step 126). An intersection between the volume of each of the plurality of article models and a volume of the second article model may be identified when each of the plurality of article models is placed in its respective location and the second article model is placed at its location. An intersection between the volume of each of the plurality of article models and a volume of the second article model may be identified when movement of any of the plurality of article models or the second article model within the environmental model is detected (Step 128). A volume of the plurality of article models corresponding to the volume of the bounding box at the intersection of one of the plurality of article models and the second article model may be dynamically removed from a display of each of the plurality of article models on the two-dimensional electronic display at a location of the intersection when any of the plurality of article models move from a first respective location to a second respective location or the second article model moves from its first location to a second location (Step 130).

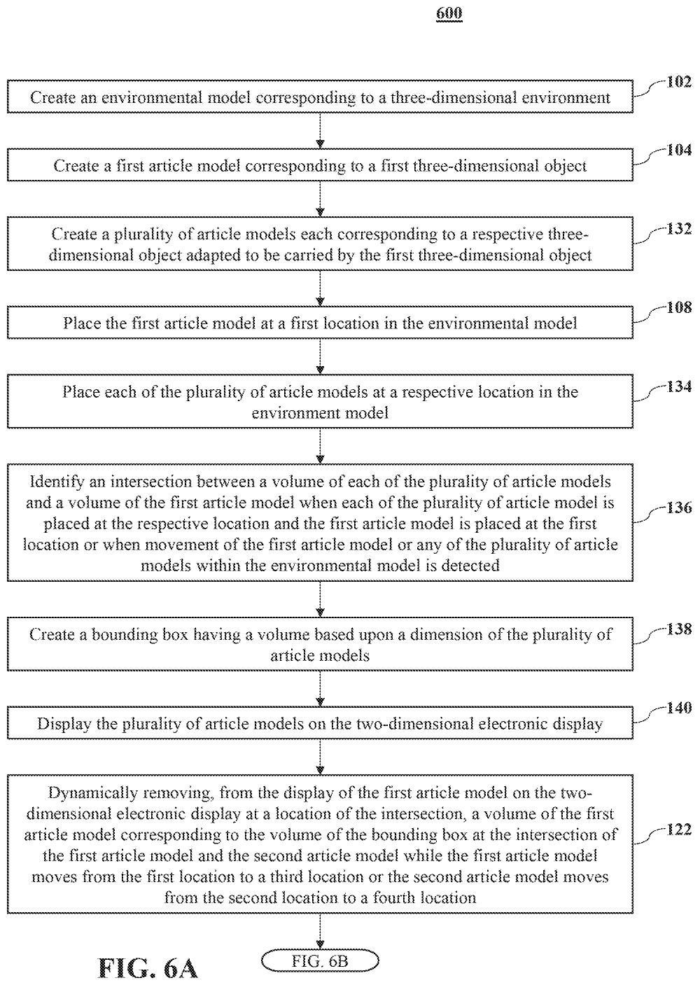

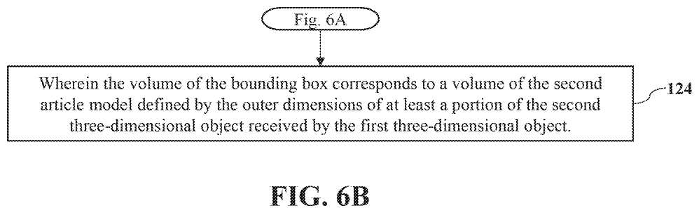

Similarly, in one embodiment, as depicted at least in FIG. 6A, a plurality of article models each corresponding to a respective three-dimensional object and each adapted to be carried by a first three-dimensional object may be created (Step 132). In such an embodiment, each of the plurality of article models may be placed at a respective location in the environment model (Step 134). An intersection between the volume of each of the plurality of article models and a volume of the first article model may be identified when each of the plurality of article models is placed in its respective location and the first article model is placed at the first location. An intersection between the volume of each of the plurality of article models and a volume of the first article model may be identified when movement of any of the plurality of article models or the first article model within the environmental model is detected (Step 136). A bounding box may be created having a volume based upon a dimension of the plurality of article models (Step 138). A plurality of bounding boxes may be created wherein a separate bounding box may be created for each of the plurality of article models with an identified intersection with the first article model. The plurality of article models may be displayed on the two-dimensional electronic display (Step 140).

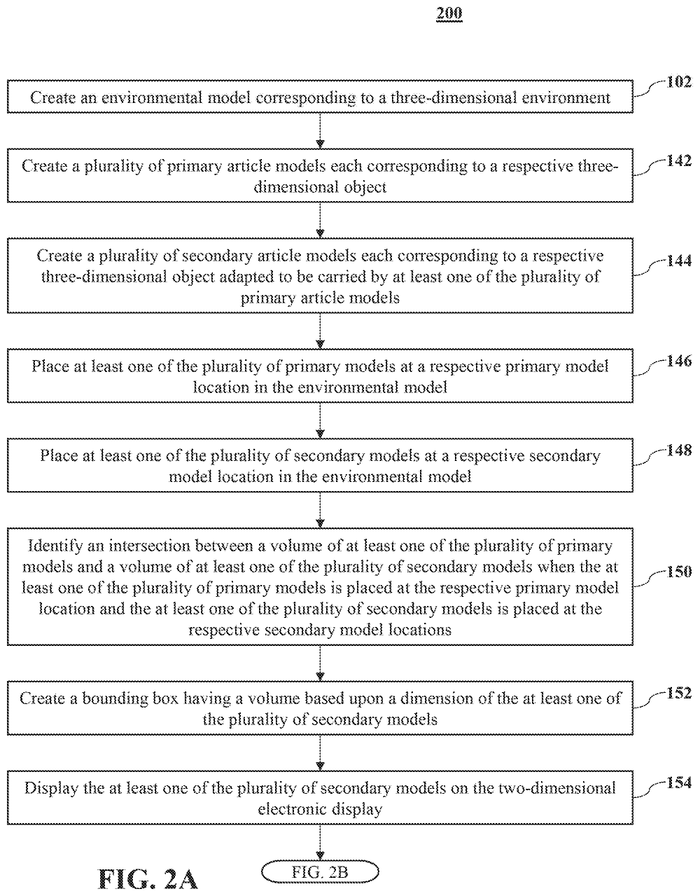

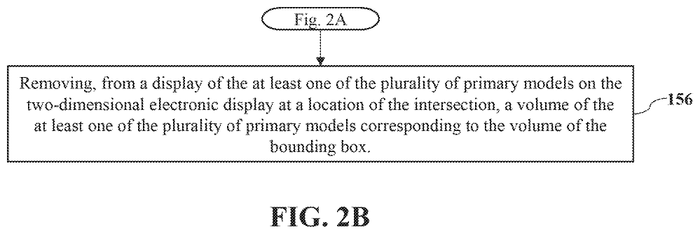

As depicted at least in FIG. 2A, a plurality of primary article models, each of which may correspond to a respective three-dimensional object, may be created (Step 142). In one embodiment, each of the primary article models may have an attribute, which identifies it as a primary article model, By way of example, and not as a limitation, such an attribute may be a floor type. A plurality of secondary article models each corresponding to a respective three-dimensional object adapted to be carried by at least one of the plurality of primary article models may be created (Step 144). In one embodiment, each of the secondary article models may have an attribute, which identifies it as a secondary article model. By way of example, and not as a limitation, such an attribute may be an embeddable type. At least one of the plurality of primary models may be placed at a respective primary model location in the environmental model (Step 146). At least one of the plurality of secondary models may be placed at a respective secondary model location in the environmental model (Step 148). An intersection between a volume of at least one of the plurality of primary models and a volume of at least one of the plurality of secondary models may be identified when at least one of the plurality of primary models is placed at the respective primary model location and at least one of the plurality of secondary models is placed at the respective secondary model location, (Step 150). A bounding box having a volume based upon a dimension of at least one of the plurality of secondary models may be created (Step 152), At least one of the plurality of secondary models may be displayed on the two-dimensional electronic display (Step 154). A volume of at least one of the plurality of primary models corresponding to the volume of the bounding box may be removed from a display of at least one of the plurality of primary models on the two-dimensional electronic display at a location of the intersection of the primary and secondary models (Step 156).

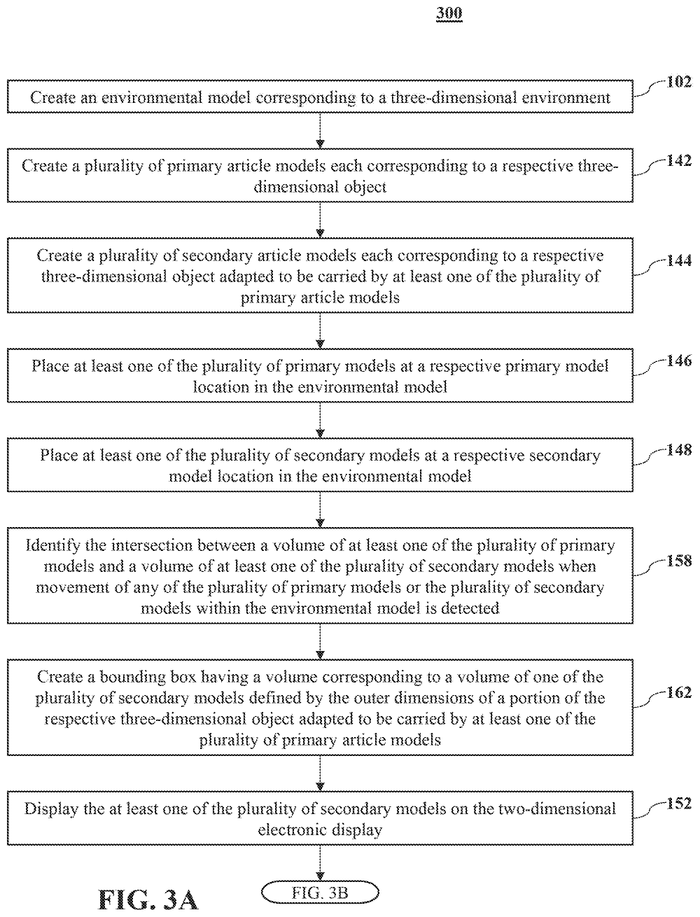

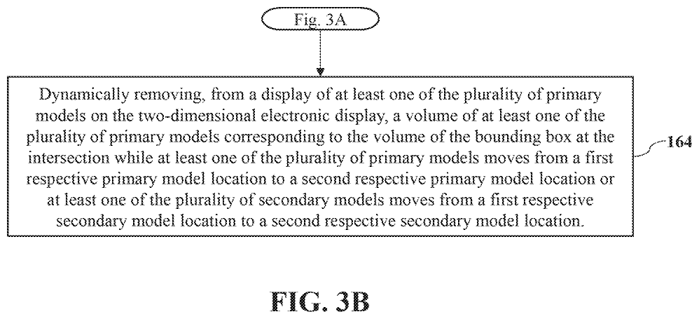

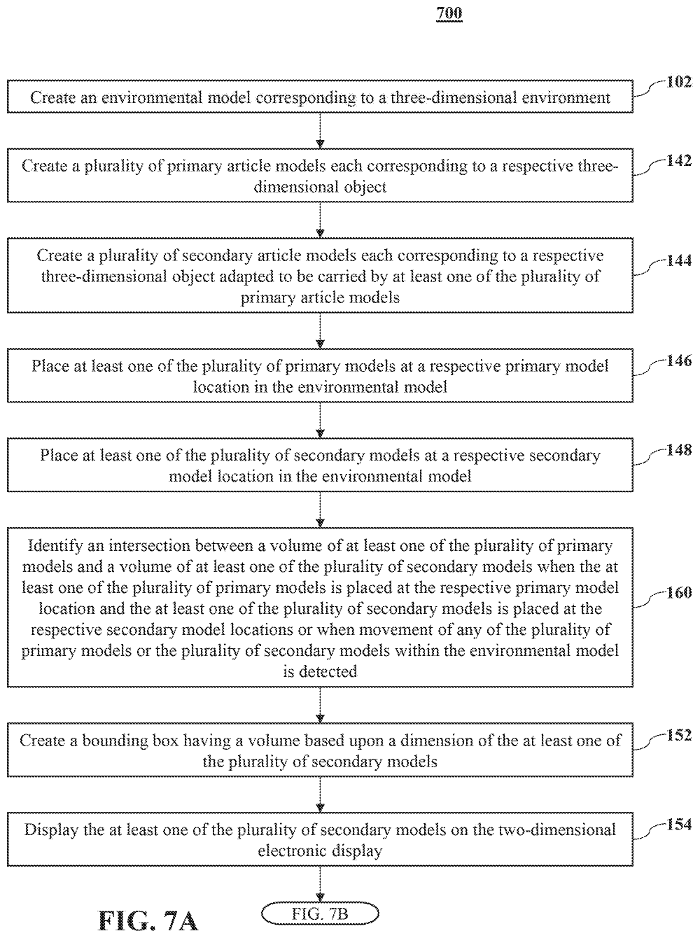

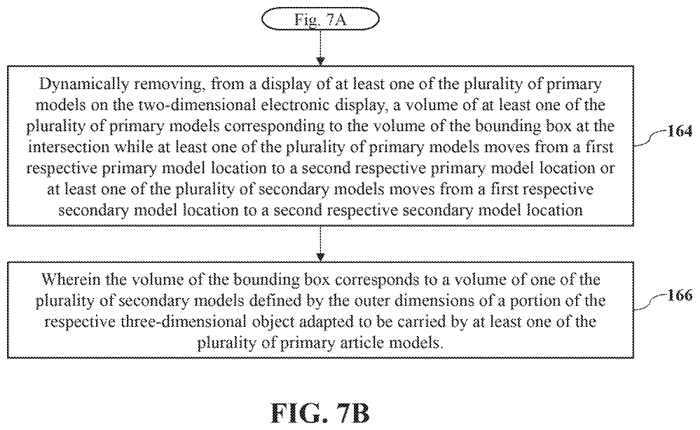

In one embodiment, as depicted at least in FIG. 3A, an intersection between a volume of at least one of the plurality of primary models and a volume of at least one of the plurality of secondary models may be identified when movement of any of the plurality of primary models or plurality of secondary models within the environmental model is detected (Step 158). As depicted at least in FIG. 7A, an intersection between a volume of at least one of the plurality of primary models and a volume of at least one of the plurality of secondary models may be identified when at least one of the plurality of primary models is placed at the respective primary model location and at least one of the plurality of secondary models is placed at the respective secondary model location. (Step 160).

Returning to FIG. 3A, a bounding box having a volume corresponding to a volume of one of the plurality of secondary models defined by the outer dimensions of a portion of the respective three-dimensional object adapted to be carried by at least one of the plurality of primary article models may be created (Step 162), As depicted at least in FIG. 7B, the volume of the bounding box may correspond to a volume of one of the plurality of secondary models defined by the outer dimensions of a portion of the respective three-dimensional object adapted to be carried by at least one of the plurality of primary article models (Step 166).

As depicted in at least FIGS. 3A and 7A, a volume of at least one of the plurality of primary models corresponding to the volume of the bounding box at the intersection may be dynamically removed from a display of at least one of the plurality of primary models on the two-dimensional electronic display while at least one of the plurality of primary models moves from a first respective primary model location to a second respective primary model location or at least one of the plurality of secondary models moves form a first respective secondary model location to a second respective secondary model location (Step 164).

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc, are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A method for representing intersecting three-dimensional article models on a two-dimensional electronic display comprising the steps of:
creating an environmental model corresponding to a three-dimensional environment:
creating a first article model corresponding to a first three-dimensional object:
creating a second article model corresponding to a second three-dimensional object adapted to be carried by the first three-dimensional object;
placing the first article model at a first location in the environmental model;
placing the second article model at a second location in the environmental model;
identifying an intersection between a volume of the first article model and a volume of the second article model when the first article model is placed at the first location and the second article model is placed at the second location;
creating a bounding box having a volume based upon a dimension of the second article model;
displaying the second article model on the two-dimensional electronic display: and
removing, from a display of the first article model on the two-dimensional electronic display, a volume of the first article model corresponding to the volume of the bounding box.

2. The method of claim 1 further comprising the step of:
identifying the intersection between a volume of the first article model and a volume of the second article model when movement of the first article model or second article model within the environmental model is detected,

3. The method of claim 1 further comprising the step of:
dynamically removing, from the display of the first article model on the two-dimensional electronic display, a volume of the first article model corresponding to the volume of the bounding box at the intersection of the first article mod& and the second article model while the first article model moves from the first location to a third location or the second article model moves from the second location to a fourth location.

4. The method of claim 1 wherein the volume of the bounding box corresponds to a volume of the second article model defined by the outer dimensions of at least a portion of the second three-dimensional object received by the first three-dimensional object.

5. The method of claim 1 further comprising the steps of:
creating a plurality of article models each corresponding to a respective three-dimensional object adapted to carry the second three-dimensional object;
placing each of the plurality of article models at a respective location in the environment model;
identifying the intersection between a volume of each of the plurality of article models and a volume of the second article mod& when each of the plurality of article model is placed at the respective location and the second article model is placed at the second location; and
removing, from a display of each of the plurality of article models on the two-dimensional electronic display at a location of the intersection, a volume of the plurality of article models corresponding to the volume of the bounding box.

6. The method of claim 1 further comprising the steps of:
creating a plurality of article models each corresponding to a respective three-dimensional object adapted to be carried by the first three-dimensional object;
placing each of the plurality of article models at a respective location in the environment model;
identifying the intersection between a volume of each of the plurality of article models and a volume of the first article model when each of the plurality of article model is placed at the respective location and the first article model is placed at the first location;
creating the bounding box having a volume based upon a dimension of the plurality of article models;
displaying the plurality of article models on the two-dimensional electronic display: and
removing, from the display of the first article model on the two-dimensional electronic display at a location of the intersection, a volume of the first article model corresponding to the volume of the bounding box.

7. A method for representing intersecting three-dimensional article models on a two-dimensional electronic display comprising the steps of:
creating an environmental model corresponding to a three-dimensional environment;
creating a plurality of primary article models each corresponding to a respective three-dimensional object;
creating a plurality of secondary article models each corresponding to a respective three-dimensional object adapted to be carried by at least one of the plurality of primary article models;
placing at least one of the plurality of primary models at a respective primary mod& location in the environmental model;
placing at least one of the plurality of secondary models at a respective secondary model location in the environmental model;
identifying an intersection between a volume of at least one of the plurality of primary models and a volume of at least one of the plurality of secondary models when the at least one of the plurality of primary models is placed at the respective primary model location and the at least one of the plurality of secondary models is placed at the respective secondary model locations;
creating a bounding box having a volume based upon a dimension of the at least one of the plurality of secondary models;
displaying the at least one of the plurality of secondary models on the two-dimensional electronic display; and
removing, from a display of the at least one of the plurality of primary models on the two-dimensional electronic display at a location of the intersection, a volume of the at least one of the plurality of primary models corresponding to the volume of the bounding box.

8. The method of claim 7 further comprising the step of:
identifying the intersection between the volume of one of the plurality of primary models and the volume of one of the plurality of secondary models when movement of any of the plurality of primary models or the plurality of secondary models within the environmental model is detected.

9. The method of claim 7 further comprising the step of:
dynamically removing, from a display of at least one of the plurality of primary models on the two-dimensional electronic display, a volume of at least one of the plurality of primary models corresponding to the volume of the bounding box at the intersection while at least one of the plurality of primary models moves from a first respective primary model location to a second respective primary model location or at least one of the plurality of secondary models moves from a first respective secondary model location to a second respective secondary model location.

10. The method of claim 7 wherein the volume of the bounding box corresponds to a volume of one of the plurality of secondary models defined by the outer dimensions of a portion of the respective three-dimensional object adapted to be carried by at least one of the plurality of primary article models.

11. A method for representing intersecting three-dimensional article models on a two-dimensional electronic display comprising the steps of:
creating an environmental model corresponding to a three-dimensional environment;
creating a plurality of primary article models each corresponding to a respective three-dimensional object;
creating a plurality of secondary article models each corresponding to a respective three-dimensional object adapted to be carried by at least one of the plurality of primary article models;
placing at least one of the plurality of primary models at a respective primary model location in the environmental model;
placing at least one of the plurality of secondary models at a respective secondary model location in the environmental model;
identifying the intersection between a volume of at least one of the plurality of primary models and a volume of at least one of the plurality of secondary models when movement of any of the plurality of primary models or the plurality of secondary models within the environmental model is detected;
creating a bounding box having a volume corresponding to a volume of one of the plurality of secondary models defined by the outer dimensions of a portion of the respective three-dimensional object adapted to be carried by at least one of the plurality of primary article models;
displaying the at least one of the plurality of secondary models on the two-dimensional electronic display; and
dynamically removing, from a display of at least one of the plurality of primary models on the two-dimensional electronic display, a volume of at least one of the plurality of primary models corresponding to the volume of the bounding box at the intersection while at least one of the plurality of primary models moves from a first respective primary model location to a second respective primary model location or at least one of the plurality of secondary models moves from a first respective secondary model location to a second respective secondary mod& location.
